(19) United States
(12) Patent Application Publication
(10) Pub. No.: US 2013/0313248 A1
(43) Pub. Date: Nov. 28, 2013

(54) FOOD HEATING OR COOLING DEVICE

(71) Applicant: Lashonda Steele Allen, Farmington Hills, MI (US)

(72) Inventor: Lashonda Steele Allen, Farmington Hills, MI (US)

(21) Appl. No.: 13/836,228

(22) Filed: Mar. 15, 2013

Related U.S. Application Data
(60) Provisional application No. 61/652,277, filed on May 28, 2012.

(51) Int. Cl. H05B 6/12; F24C 7/08

(52) U.S. Cl. CPC H05B 6/129; F24C 7/088
USPC 219/623

(57) ABSTRACT

A food heating and/or cooling device is provided. The device has a housing with a food heating-cooling region and an opening that provides access to the heating-cooling region. An induction heating element and a cooling device is contained within the housing. A food container dimensioned to fit through the opening and within the food heating-cooling region is included, the food container having an electrically conductive element that can be heated by the induction heating element contained within the housing. Furthermore, the cooling device is operable to cool the food when it is placed within the food heating-cooling region. As such, food that is located on or within the food container and placed within the food heating-cooling region can be heated and/or cooled.

### CROSS-REFERENCE TO RELATED APPLICATIONS

This application claims priority of U.S. Provisional Application 61/652,277 filed May 28, 2012, the contents of which are incorporated herein by reference.

### FIELD OF THE INVENTION

The present invention is related to a device for heating or cooling food, and in particular for heating and cooling food to ensure that the food is not too hot or cold for a toddler/child to eat.

### BACKGROUND OF THE INVENTION

Preparing food for a child such as a toddler is a common everyday occurrence for families having young children in the household. In addition, parents can struggle to provide food at “just the right temperature” for their children while at the same time preparing the children and/or themselves for activities such as school, soccer practice, work and the like. As such, it is not uncommon for parents to be very busy during the preparation of meals for their children.

When a meal, snack, etc. has been heated in an oven, on the stove, or in a microwave, it is common for one of the parents to test the temperature of the food in order to make sure that it is not too hot for the child to eat. In addition, it is common for the parent to “blow” on the food, either when it is on a plate or in a bowl or after a portion of the food has been placed on an eating utensil such as a spoon or fork. In this manner, the parent ensures that the child does not burn their mouth by taking a bite of food that is too hot.

Given the above, a device that ensures that food to be eaten by a child is not too hot and allows a parent to continue dealing with other activities would be desirable. In addition, a device that could heat food in the event that the food has been allowed to “cool off” too much would also be desirable.

### SUMMARY OF THE INVENTION

A food heating or cooling device is provided. The device has a housing with a food heating-cooling region and an opening that provides access to the heating-cooling region. An induction heating element and a coiling device is contained within the housing. A food container dimensioned to fit through the opening and also fit within the food heating-cooling region is also included, the food container having an electrically conductive element that can be heated by the induction heating element contained within the housing. As such, food that is located on or within the food container and placed within the food heating-cooling region can be heated by the induction heating element. Furthermore, the cooling device, e.g. a fan, is operable to cool the food when it is placed within the food heating-cooling region.

In some instances, the food heating-cooling region has a bottom surface and a top surface, and the induction heating element is located below the bottom surface and the cooling device is located above the top surface. In such an arrangement, the cooling device blows air down onto food placed within the heating-cooling region. In other instances, air from within the food heating-cooling region will be blown on the food. In addition, cooling devices can be located within the sides of the heating-cooling region. In addition, the bottom surface remains “cool to the touch” when the induction heating element is heating the food container via the electrically conducting element. Likewise, the food container has a non-electrically conducting portion surrounding the electrically conducting element that is cool to the touch during and after heating of the food container. It is appreciated that the electrically conducting element is an induction conducting element made out of any induction conducting element known to those skilled in the art such as copper, stainless steel and the like.

A cooling element that is operable to cool air that flows through the cooling device and onto the food can also be included. In addition, a heat sink that is operable to conduct heat from the cooling element and/or from air that flows and comes into contact with the heat sink can be provided. In some instances, the housing has a cooling unit opening in which air from outside of the housing is provided to the cooling device and thus affords for air flow into the food heating-cooling region. In addition, the cooling device, the cooling element, and the heat sink can be located within the cooling unit opening.

In some instances, a temperature sensor that is operable to determine a temperature of food located within the food heating-cooling region is included. The temperature sensor can be a non-contact temperature sensor, for example an infrared temperature sensor. An electronic control unit (ECU) can be included and be in electrical communication with the temperature sensor and at least one of the induction heating element and the cooling device. The ECU can activate the induction heating element and/or the cooling device as a function of the temperature determined by the temperature sensor. In addition to the temperature sensor, a thermostat can be included and be in communication with the ECU such that the ECU is operable to activate the induction heating element and/or the cooling device as a function of a thermostat temperature setting and a temperature determined by the temperature sensor.

### BRIEF DESCRIPTION OF THE DRAWINGS

FIG. 1 is a perspective view of a food heating and/or cooling device according to an embodiment of the present invention;

FIG. 2 is a perspective view of the food heating and/or cooling device shown in FIG. 1 illustrating a food container being placed within a food heating-cooling region of the device;

FIG. 3 is a perspective front cross-sectional view of the food heating and/or cooling device shown in FIGS. 1 and 2;

FIG. 4 is an exploded view of heating and cooling components for the device shown in FIGS. 1-3;

FIG. 5 is a schematic diagram of electronic circuitry for the device shown in FIGS. 1-3;

FIG. 6 is a perspective view of a food cooling device according to an embodiment of the present invention;

FIG. 7 is a perspective side cross-sectional view of a figurine portion shown in FIG. 6; and

FIG. 8 is a perspective side cross-sectional view of a clip shown within the figurine illustrated in FIG. 7.

### DETAILED DESCRIPTION OF THE INVENTION

A food heating and/or cooling device that affords for heating and/or cooling food to a desired temperature such that a child does not take a bite of the food when it is too hot or cold is provided. As such, the food heating and/or cooling device has utility as a home appliance.

The food heating and/or cooling device according to one embodiment includes a housing with a food heating-cooling region and an opening that provides access to the food heating-cooling region. The device also includes an induction heating element that has an electromagnet through which high frequency alternating current (AC) is passed. A cooling device, e.g. a fan, is also included with the housing and a food container dimensioned to fit through the opening and be placed within the food heating-cooling region is provided.

The food container has an electrically conductive element surrounded by a non-electrically conductive portion such that the food container has the shape of a plate, bowl, and the like and is not “hot to the touch” before, during, and/or after the electrically conductive element has been heated by the induction heating element. In some instances, an insulating layer or insulating portion can be present between the electrically conductive element and the non-electrically conductive portion of the food container. For the purposes of the present invention, the terms “hot to the touch” is defined as a temperature or range of temperatures of a given object or surface which feels too hot and/or provides a burning sensation to an individual that touches or holds the particular object or surface. For example and for illustrative purposes only, the non-electrically conductive portion can maintain a temperature between 42-49 degrees centigrade (109-120 degrees Fahrenheit) during and after being heated by the induction heating element. However, it is appreciated that a suitable temperature or range of temperatures for eating can vary based on a food's fat content, watwer content, etc.

It is appreciated that the heating of the electrically conductive element by the induction heating element occurs via induction heating as is known to those skilled in the art. For example, the electrically conductive element of the food container is heated by electromagnetic induction where eddy currents are generated within the element material and resistance within the material leads to Joule heating of the element. Heating of the electrically conducting element can also be generated by magnetic hysteresis losses within the material. Naturally, the food heating or cooling device has a power supply such as batteries, an electrical cord to be plugged into an electrical outlet that has power, and the like.

The cooling device of the food cooling and/or heating device is operable to cool food when placed within the food heating-cooling region by forcing air onto the food. In some instances, the cooling device is a fan and a cooling element can be placed in front of or behind the fan such that air being forced onto the food is further cooled. Such a cooling element can for example be made from a thermoelectric cooling element, a refrigerated element, and the like. In addition to the cooling element, one or more heat sinks can be included that conduct heat from air that comes into contact therewith and/or conducts heat away from the cooling element.

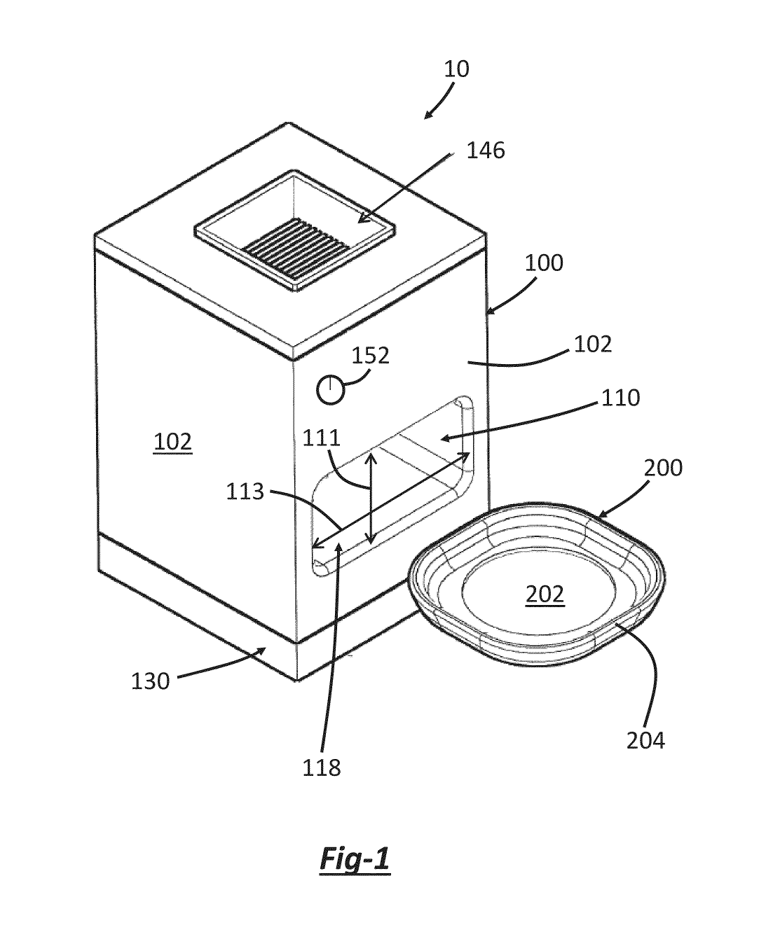

Turning now to FIGS. 1-3, an embodiment of a food heating and/or cooling device according to an embodiment of the present invention is shown generally at reference numeral 10. The food heating and/or cooling device 10 has a housing 100 with one or more side walls 102 and a food heating-cooling region 110. The food heating-cooling region 110 has an opening 118 that affords access to the food-cooling region 110.

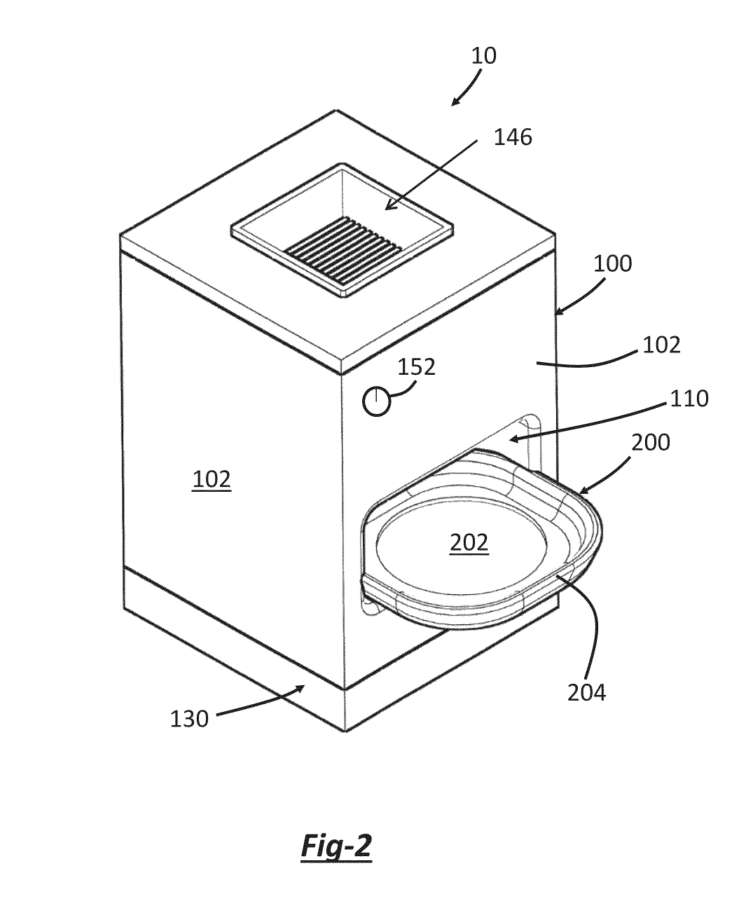

The device 10 can include a food container 200 that has an electrically conductive element 202 and a non-electrically conductive portion 204. The opening 118 has a height 111 and a width 113 with dimensions that allow for the food container 200 to slide therethrough and be placed within the food heating-cooling region 110 as illustrated in FIG. 2.

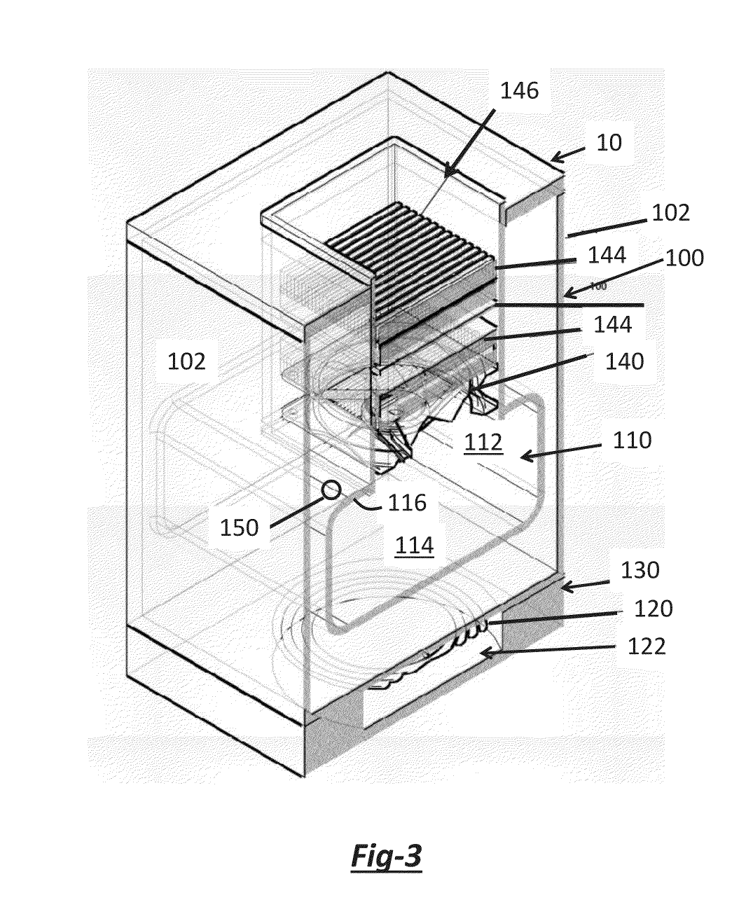

Looking particularly at FIG. 3, a cross-sectional view of the device 10 is shown. The device 10 has a base 130 with an induction heating element 120 located within a cavity 122. The cavity 122 can have free space around the element 120, or in the alternative, the base 130 can be molded around the element 120 such that there is no free space between the base 130 and element 120. It is appreciated that the induction heating element 120 can be any induction heating element known to those skilled in the art that affords for induction heating of an electrically conductive element.

The food heating-cooling region 110 can have a side surface 112, a bottom surface 114, and a top surface 116. As shown in the figure, the induction heating element 120 can be located below the bottom surface 114 of the food heating-cooling region 110 within the base 130.

A cooling device 140, illustratively shown as a fan, is provided and can be in fluid communication with the food heating-cooling region 110. The cooling device 140 is operable to blow or force air from outside of the device 10 into the food heating-cooling region 110. In addition to the fan 140, the device 10 can have a cooling element 142 and one or more heat sinks 144. Furthermore, the fan 140, cooling element 142, and one or more heat sinks 144 can be located within a cooling unit opening 146 that affords for the flow of air from an area or region above the device 10 into the food heating-cooling region 110.

A temperature sensor 150 that can be a non-contact temperature sensor such as an infrared temperature sensor can also be part of the device 10. The temperature sensor is operable to estimate or determine a temperature of an object such as food placed within the food heating-cooling region 110. The device 10 may or may not have a thermostat 152 that allows an individual the set a desired temperature for the food to be heated or cooled to.

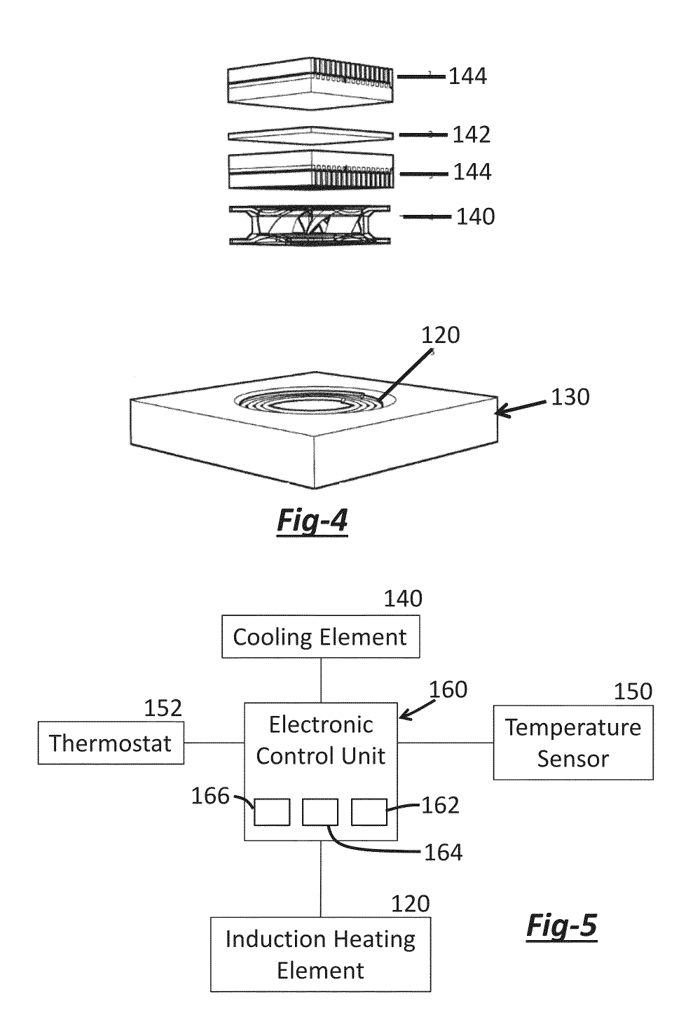

Referring to FIG. 4, an exploded view of the various heating and cooling components described in FIG. 3 is shown. The induction heating element 120 within the base 130, as well as the fan 140, cooling element 142, and one or more heat sinks 144 are shown. In addition, FIG. 5 provides a schematic diagram of an electronic circuit between the induction heating element 120, fan 140, temperature sensor 150, optional thermostat 152 and an electronic control unit (ECU) 160. The ECU 160 can have memory 162, a software module 164, and a programmable module 166. It should be appreciated that the ECU is in communication with the various components of the device 10 through wireless communication, wired communication, and the like.

In operation, the device 10 can have a preprogrammed desired temperature for food placed within the food heating-cooling region 110. Food is placed within the food heating-cooling region 110 and the temperature sensor 150 determines a temperature of the food and sends a temperature signal to the ECU 160. Based on the temperature, the ECU 160 activates the induction heating element 120 or the cooling device 140. In the event that the food is too cold, i.e. a temperature of the food is below the desired temperature, the induction heating element 120 is activated which in turn induction heats the electrically conductive element 202 of the food container 200. The heated electrically conductive element 202 transfers heat to the food on the container 200.

It should be appreciated that the ECU 160 with the programmable module 164 and software module 166 can be programmed to activate the induction heating element 120 for a specific time and/or with a specific power based on the type of food placed on or within the food container 200 and/or the temperature of the food determined by the temperature sensor 150. Such settings for the time of activation of the induction heating element and/or the power provided to the induction heating element can be based on experimental testing, artificial learning by the ECU 160, software module 166, etc.

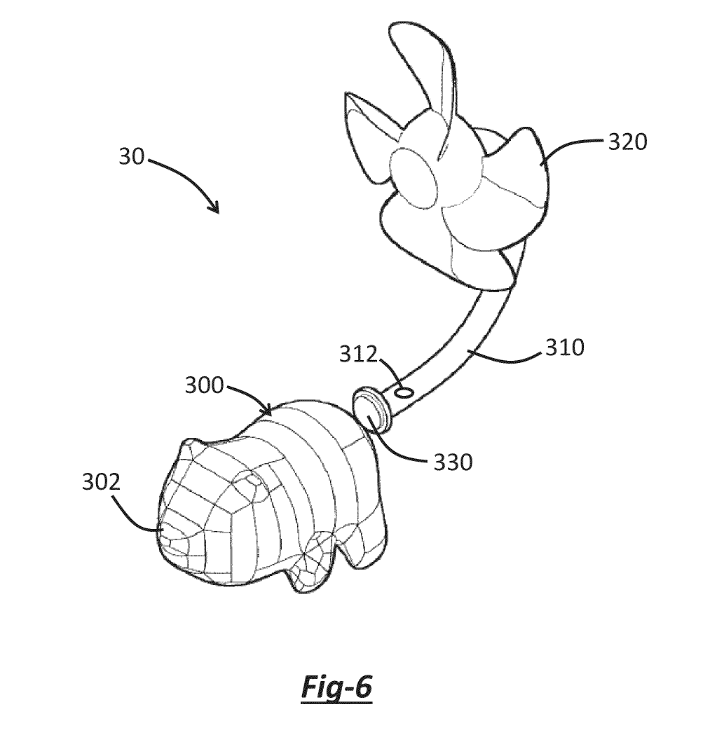

Turning now to FIGS. 6-8, another embodiment of a food heating and/or cooling device is shown generally at reference numeral 30. In this embodiment, the device 30 provides cooling to food that has been heated to a temperature that is too hot for a child to eat. The device 30 has a figurine 300 and a fan portion with a flexible neck or rail 310 that allows for angle control and direction choice, a fan 320 and a battery 330 that provides electrical power to the fan 320 upon activation of an On/Off switch 312. In some instances, a bladeless cooling device can be used instead of or in addition to the fan 320. In addition, the fan can be within a protective cover such as a cage.

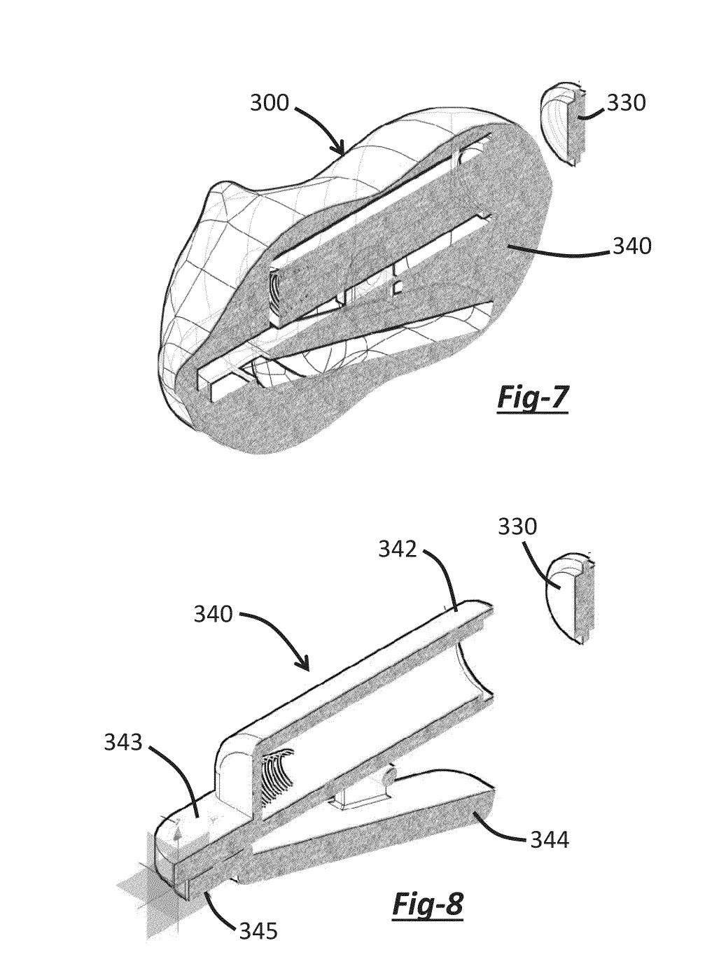

The figurine 300 can be made from a flexible or pliable material such as a polymer that allows for pressure to be applied to a rear and/or center portion of the figurine 300 and transmitted to a clip 340 included therewithin as illustrated in FIG. 7. The clip 340 is enclosed within a body of the figurine 300 and has a pair of opening levers 342, 344 that the pressure can be transmitted/applied to, which in turn affords for opening of jaw members 343, 345 which are located in a mouth region 302 of the figurine 300. In this manner, the mouth portion 302 can be opened and used to clamp the figurine 300 to a component such as a plate, seat belt, and the like. In addition, the figurine 300 can have other types of fastening devices, e.g. one or more magnets, which allow for the cooling device 30 to be attached to a desired object.

In operation the battery 330 is activates and the fan 320 blows air onto food given or to be given to a child. For example and for illustrative purposes only, parents will appreciate that it is not uncommon to purchase food at a fast food facility, e.g. a hamburger and french fries at a fast food restaurant “drive-through,” and the food is too hot for a child to eat at the present time. As such, the cooling device 300 is attached to the child's safety belt, child safety/restraint seat, etc., and activated to blow air onto the food. In should be appreciated that the cooling device 300 is also self-standing. In this manner, the hot food is cooled in a reduced amount of time while the parent is attending to other children, driving and the like.

The invention is not limited by the embodiments, examples, and the like described herein. In addition, the housing of the device, food container, figurine, stem, and fan can be made from any material known to those skilled in the art that provides an aesthetically pleasing and safe material to be handled, moved, and used for heating and/or cooling food, etc. Such materials include polymers, metals, wood, and the like. The specification should be interpreted broadly and the scope of the invention is covered by the claims and any equivalents thereof.

I claim:

1. A food heating or cooling device comprising:
a housing having a food heating-cooling region and an opening providing access to said heating-cooling region;
an induction heating element contained within said housing;
a fan contained within said housing;
a food container dimensioned to fit through said opening and fit within said food heating-cooling region, said food container having an electrically conductive element;
said induction heating element operable to heat said electrically conductive element when said food container is located within said food heating-cooling region and said electrically conductive element operable to heat food when placed on said food container;
said fan operable to cool food when placed within said food heating-cooling region.

2. The food heating or cooling device of claim 1, wherein said food heating-cooling region has a bottom surface and a top surface, said induction heating element located below said bottom surface and said fan is located above said top surface.

3. The food heating or cooling device of claim 2, wherein said bottom surface remains cool to the touch when said induction heating element is heating said food container electrically conducting element.

4. The food heating or cooling device of claim 3, wherein said fan is operable to blow air onto food placed within said food heating-cooling region.

5. The food heating or cooling device of claim 4, further comprising a cooling element operable to cool air flowing through said fan and onto the food within said heating-cooling region.

6. The food heating or cooling device of claim 5, further comprising a heat sink operable to conduct heat from said cooling element.

7. The food heating or cooling device of claim 6, wherein said heat sink is operable to conduct heat from air before or after flowing through said fan.

8. The food heating or cooling device of claim 7, further comprising a cooling unit opening, said cooling unit opening providing access for air from outside said housing to flow into said food heating-cooling region.

9. The food heating or cooling device of claim 8, wherein said fan, cooling element and heat sink are located within said cooling unit opening.

10. The food heating or cooling device of claim 1, wherein said food container has a non-electrically conductive plate portion surrounding said electrically conductive element.

11. The food heating or cooling device of claim 10, wherein said non-electrically conductive plate portion remains cool to the touch during and after said electrically conductive element is heated by said induction heating element.

12. The food heating or cooling device of claim 1, further comprising a temperature sensor operable to determine a temperature of food located within said food heating-cooling region.

13. The food heating or cooling device of claim 12, further comprising an electronic control unit (ECU) in electrical communication with said temperature sensor and at least one of said induction heating element and said fan.

14. The food heating or cooling device of claim 13, wherein said ECU activates at least one of said induction heating element and said fan as a function of said temperature determined by said temperature sensor.

15. The food heating or cooling device of claim 14, wherein said temperature sensor is a non-contact temperature sensor.

16. The food heating or cooling device of claim 14, wherein said non-contact temperature sensor is an infrared temperature sensor.

17. The food heating or cooling device of claim 14, further comprising a thermostat in communication with said ECU, said ECU operable to activate at least one of said induction heating element and said fan as a function of said temperature determined by said temperature sensor and a temperature setting of said thermostat.

18. A food heating or cooling device comprising:
a housing having a food heating-cooling region and an opening dimensioned to provide access to said food heating-cooling region;
an inductive heating element and a fan contained within said housing;
an inductive heatable food container;
a temperature sensor operable to detect a temperature of food located within said food heating-cooling region; and
a thermostat in communication with said temperature sensor, said inductive heating element and said fan,
said thermostat operable to activate said inductive heating element and said fan as a function of a temperature detected by said temperature sensor when said food container is located within said heating or cooling region.

19. The food heating or cooling device of claim 18, wherein said food heating-cooling region has a bottom surface and a top surface, said induction heating element located below said bottom surface and said fan is located above said top surface.

20. The food heating or cooling device of claim 19, wherein said bottom surface remains cool to the touch when said induction heating element is heating said food container electrically conducting element.
